(19) United States
(12) Patent Application Publication
(10) Pub. No.: US 2009/0103652 A1
(43) Pub. Date: Apr. 23, 2009

(54) SAMPLING RECEIVER

(75) Inventors: Masahiro Mabuchi, Kyoto (JP); Jinichi Tamura, Kyoto (JP); Shinichiro Uemura, Osaka (JP); Miki Yamanaka, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/210,465

(22) Filed: Sep. 15, 2008

(30) Foreign Application Priority Data
Oct. 17, 2007 (JP) 2007-269592

(51) Int. Cl. H04L 27/06

(52) U.S. Cl. 375/316

(57) ABSTRACT

The switching operation of a high frequency switch connected in series downstream from the amplifier circuit produces a load variation on the amplifier circuit, and serially connecting the amplifier circuit and high frequency switch causes a drop in gain due to an in-band mismatch. An amplifier circuit is connected to the input pin for input a high frequency signal, and the output of the amplifier circuit branches to serially connected resistances. An RC filter composed of a resistance and a capacitance is parallel connected between the resistances and the downstream high frequency switches. Input pins for inputting a high frequency signal are connected to the gates of the high frequency switches. Capacitances are parallel connected downstream from the high frequency switches, forming a switched capacitor circuit connected to the output pins.

### BACKGROUND OF THE INVENTION

1. Field of Invention

The present invention relates to technology for a wireless receiver including a mobile terminal device, and relates more particularly to a sampling receiver.

2. Description of Related Art

Receivers in wireless systems such as the cellular telephone system amplify the signal received through the antenna using a first-stage amplifier circuit, input the amplified signal to a downstream sampling receiver for frequency conversion, and then input the frequency-converted signal to a signal processing circuit. The sampling receiver has a function for amplifying and frequency converting a weak input signal. This requires low distortion, high gain performance. The interference characteristic becomes a problem particularly in modern mobile communications when the mobile station is below the base station and receives an adjacent channel. When three receivers are below the base station and communicating on adjacent channels, distortion caused by one receiver receiving the two channels used by the other receivers in addition to the channel used by itself can cause a drop in reception sensitivity when this distortion occurs in the signal band used by the one receiver. To prevent this, the sampling receiver requires a low distortion circuit characteristic together with a high gain characteristic in order to assure sufficient reception sensitivity.

Many different receiver designs are known from the literature. One technology that has been used to take advantage of advances in semiconductor integration is direct sampling. This method samples the received signal, which is a continuous high frequency signal, at a high frequency, and simultaneously frequency converts the signal to a baseband signal and to a discrete signal. An example of this technology is the frequency conversion device taught in U.S. Patent Application Publication No. 2005/0104654 A1, which provides multiple filter stages after the frequency conversion step to achieve a sharp frequency characteristic and reduce distortion.

In the sampling receiver according to the related art described above, the devices affording low distortion are used in the circuitry downstream from the frequency conversion stage, and the input amplifier circuit and high frequency switch are directly connected. An impedance mismatch therefore occurs because the output impedance of the amplifier circuit and the input impedance of the high frequency switch do not match, and a loss of gain and an increase in distortion in the output signal is a problem.

### SUMMARY OF THE INVENTION

The present invention solves the foregoing problem by providing a sampling receiver that matches the output impedance of the amplifier circuit and the input impedance of the high frequency switch while reducing distortion without reducing gain in the amplifier circuit.

A sampling receiver according to first aspect of the invention has an amplifier unit that amplifies a high frequency signal and generates an amplified signal, a buffer unit that generates a buffer signal that impedance matches the amplified signal, and a sampling unit that samples the buffer signal at a desired frequency, and generates a sample hold signal. The buffer unit absorbs impedance variation caused by the sampling operation of the sampling unit.

Preferably, the buffer unit includes a serial buffer unit inserted in series between the amplifier unit and the sampling unit, and a parallel buffer unit inserted in parallel between the amplifier unit and sampling unit.

Further preferably, the serial buffer unit is inserted between the amplifier unit and parallel buffer unit.

In another aspect of the invention the parallel buffer unit is inserted between the amplifier unit and serial buffer unit.

In another aspect of the invention the serial buffer unit includes at least one of a resistor, an inductor, and a capacitor.

Further preferably, the serial buffer unit includes a circuit having a parallel connected inductor and capacitor.

In another aspect of the invention the parallel buffer unit includes at least two of a resistor, an inductor, and a capacitor.

In another aspect of the invention the sampling receiver also has a control unit that supplies power to the sampling unit and controls switching the power supply on and off.

In this aspect of the invention, the control unit is preferably inserted between the serial buffer unit and parallel buffer unit.

Alternatively, the control unit is inserted between the buffer unit and sampling unit.

In the sampling receiver according to another aspect of the invention the buffer unit includes a first secondary buffer unit that includes the serial buffer unit and the parallel buffer unit, and a second secondary buffer unit that includes the parallel buffer unit. In addition, the sampling receiver also has a switch unit that selects a first channel through which the amplified signal is input to the first secondary buffer unit or a second channel through which the amplified signal is input to the second secondary buffer unit, and an amplitude level detection circuit that detects the amplitude level of the amplified signal and generates an amplitude level signal. The switch unit selects the channel based on the amplitude level signal; and the buffer unit generates the buffer signal based on the amplified signal input thereto through the selected channel.

Further preferably, the sampling unit changes the gain of the sample hold signal to the buffer signal based on the amplitude level signal.

In the sampling receiver according to another aspect of the invention the amplifier unit generates an amplified signal on two channels based on a high frequency signal on one channel; the buffer unit generates buffer signals on two channels based on the two amplified signals; and the sampling unit generates sample hold signals on two channels based on the two buffer signals.

Further preferably, the amplifier unit includes a differential conversion circuit that generates opposite-phase amplifier input signals on two channels based on one high frequency signal; and an amplifier circuit that amplifies the two amplified input signals and generates two opposite-phase amplified signals.

Further preferably, the amplifier unit includes an amplifier circuit that amplifies one high frequency signal and generates an amplified output signal on one channel; and a branching circuit that splits the one amplified output signal and generates same-phase amplified signals on two channels.

Alternatively, the amplifier unit includes an amplifier circuit that amplifies one high frequency signal and generates an amplified output signal on one channel; and a differential conversion circuit that generates opposite-phase amplified signals on two channels based on the one amplified output signal.

Further preferably, the differential conversion circuit includes a differential inductor.

In another aspect of the invention the differential conversion circuit includes a differential transformer that converts a one-channel primary power signal to opposite-phase secondary power signals on two channels.

In another aspect of the invention the amplifier unit converts the high frequency signal voltage to current and generates the amplified signal.

In another aspect of the invention the sampling receiver also has a switched capacitor filter that limits the frequency band of the sample hold signal.

Preferably, the switched capacitor filter includes at least first and second clocked inverters cascaded with each other, a capacitor inserted in parallel between the first clocked inverter and second clocked inverter, and an inverter inserted in series between the capacitor and the second clocked inverter.

In the sampling receiver according to the present invention the amplifier unit generates to two channels each having a resistance connected in series that suppresses load variation caused by the switching operation of the sampling unit connected in series downstream from the resistances.

By inserting an inductor and capacitance in parallel series instead of the resistances connected in series, the load variation produced by the switching operation of the sampling unit connected downstream can also be suppressed at the parasitic resistance of the inductor lines.

A resistance and capacitance are also parallel connected between the resistance and downstream sampling unit, thereby enabling filtering harmonics produced by the sampling unit and in-band matching. This is also possible when the inductor and capacitance are parallel connected.

Using only one of these measures does not effectively reduce distortion. Simply inserting a resistance in series cannot reduce harmonics produced by the high frequency switch, and simply inserting a resistance and capacitance in parallel cannot suppress the load variation on the upstream amplifier circuit caused by the input impedance of the high frequency switch. However, combining both of these measures can suppress distortion produced by the amplifier circuit and the high frequency switch, and a drop in gain can be prevented by impedance matching.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a circuit diagram of a sampling receiver according to a first embodiment of the invention.

FIG. 2 is a circuit diagram of the amplifier circuit in the first embodiment of the invention.

FIG. 3 is a circuit diagram of a sampling receiver according to a second embodiment of the invention.

FIG. 4 is a circuit diagram of a sampling receiver according to a third embodiment of the invention.

FIG. 5 is a circuit diagram of a sampling receiver according to a variation of the third embodiment of the invention.

FIG. 6 is a circuit diagram of a sampling receiver according to a fourth embodiment of the invention.

FIG. 7 is a circuit diagram of a sampling receiver according to a variation of the fourth embodiment of the invention.

FIG. 8 is a circuit diagram of a sampling receiver according to a fifth embodiment of the invention.

FIG. 9 is a circuit diagram of a sampling receiver according to a first variation of the fifth embodiment of the invention.

FIG. 10 is a circuit diagram of a sampling receiver according to a second variation of the fifth embodiment of the invention.

FIG. 11 is a circuit diagram of a sampling receiver according to a sixth embodiment of the invention.

FIG. 12 is a circuit diagram of the amplifier circuit in the sixth embodiment of the invention.

FIG. 13 is a circuit diagram of a sampling receiver according to a seventh embodiment of the invention.

FIG. 14 is a circuit diagram of a sampling receiver according to an eighth embodiment of the invention.

FIG. 15 is a circuit diagram of a switched capacitor circuit according to a ninth embodiment of the invention.

FIG. 16 is a plan view of the differential inductor in the fifth embodiment and the first variation of the fifth embodiment of the invention.

FIG. 17 is a graph of the simulation values acquired using the sampling receiver according to preferred embodiments of the invention.

### DETAILED DESCRIPTION OF THE PREFERRED EMBODIMENTS

Preferred embodiments of the present invention are described below with reference to the accompanying figures. Note that parts with the same arrangement, operation, and effect are denoted by the same reference numerals in the accompanying figures. The numbers used below and in the figures are also merely to describe a specific embodiment of the invention, and the invention is not limited to those numbers. In addition, logic levels denoted high and low, and switch states denoted on and off, are also only used by way of example to describe a specific embodiment of the invention, and it will be obvious that the same effect can be achieved using different combinations of the exemplary logic levels and switching states cited below. Furthermore, the connections between particular parts described below are also used to describe a specific embodiment of the invention, and the connections achieving the function of the invention are not limited to those described below.

### Embodiment 1

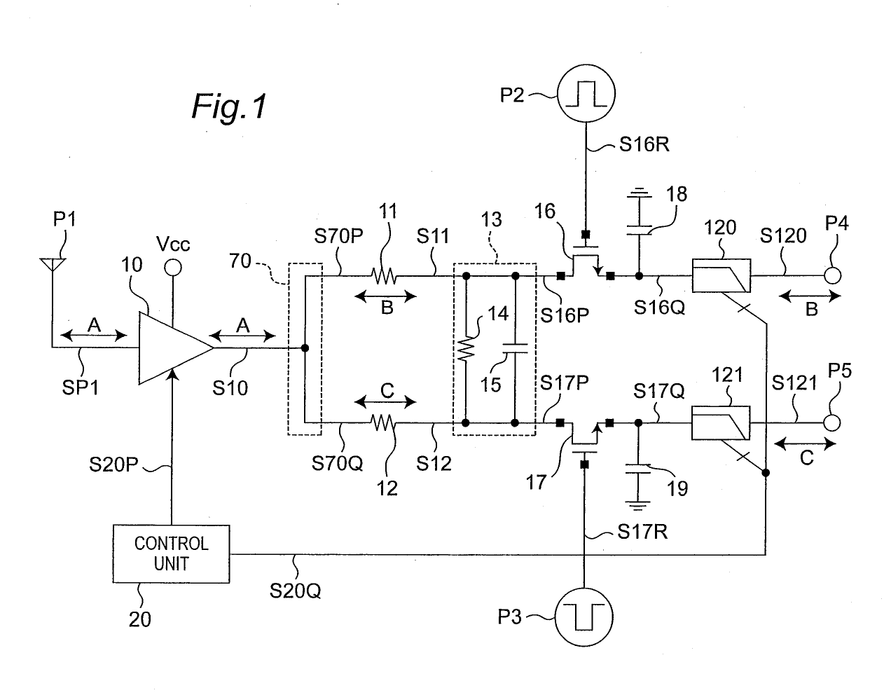

FIG. 1 is a circuit diagram of a sampling receiver according to a first embodiment of the invention.

The sampling receiver according to this first embodiment of the invention includes an input pin P1 to which a high frequency switch is input, an amplifier circuit 10 connected to the input pin P1, resistances 11 and 12 parallel connected in series to the output of the amplifier circuit 10, an RC filter 13 parallel connected between the resistances 11 and 12 and downstream high frequency switches 16 and 17, a resistance 14 and a capacitance 15. Input pins P2 and P3 for inputting high frequency signals are also connected to the gates of the high frequency switches 16 and 17, respectively. Capacitances 18 and 19 are parallel connected to the high frequency switches 16 and 17 on the downstream side, rendering switched capacitor circuits. The high frequency switches 16 and 17 are also connected to switched capacitor filters 120 and 121, which are connected to the output pins P4 and P5.

The resistances 11 and 12 connected in series to the output of the amplifier circuit 10 are connected to suppress load variation on the amplifier circuit 10 caused by the switching operations of the high frequency switches 16 and 17. The resistance 14 and capacitance 15 are parallel connected in the RC filter 13, which reduces harmonics by filtering the harmonic output of the high frequency switches 16 and 17 and provides in-bandwidth matching. An increase in device size is also avoided by limiting the number of components used.

The construction shown in FIG. 1 is described next from a different perspective.

The amplifier unit includes the amplifier circuit 10 and a branching circuit 70. In a typical application, the input pin P1 is connected to an antenna that can receive RF signals. The amplifier unit amplifies a high frequency signal SP1 on one channel A from the input pin P1, and outputs amplified signals S70P and S70Q on two channels B and C.

The amplifier circuit 10 amplifies the high frequency signal SP1 and outputs amplified output signal S10. In a typical application the amplifier circuit 10 converts the voltage of the high frequency signal SP1 to current and generates the amplified output signal S1.

The branching circuit 70 splits the amplified output signal S10 on channel A into amplified signals S70P and S70Q of substantially equal amplitude, frequency, and phase on channels B and C.

A buffer unit includes a serial buffer unit rendered by the resistances 11 and 12, and a parallel buffer unit 13. Based on the amplified signals S70P and S70Q on channels B and C, the buffer unit generates buffered signals S16P and S17P on channels B and C. The serial buffer unit is connected to the downstream side of the amplifier unit, and the parallel buffer unit 13 is connected to the downstream side of the serial buffer unit. The serial buffer unit includes resistances 11 and 12. Resistances 11 and 12 are inserted in series to channels B and C, respectively. The parallel buffer unit 13 includes resistance 14 and capacitance 15, which are inserted in parallel between channel B and channel C.

The sampling unit includes high frequency switch 16 and capacitance 18 on channel B, and the high frequency switch 17 and capacitance 19 on channel C. The sampling unit samples the buffered signals S16P and S17P on channels B and C according to the sampling clock signals S16R and S17R of a desired frequency output by a local oscillator (not shown in the figure), and generates the sample hold signals S16Q and S17Q for channels B and C. In a typical application there is a 180° phase difference between sampling clock signals S16R and S17R.

The frequency band FSHW of the sample hold signals S16Q and S17Q is expressed as shown below using the frequency FSC of the sampling clock signals S16R and S17R (also called the sampling clock frequency), the minimum frequency FIN1 and maximum frequency FIN2 of the specific frequency band FINW of the buffered signals S16P and S17P to be received, the difference frequency band FSHWM between the sampling clock frequency FSC and the specific frequency band FINW, and the frequency band sum FINP of the sampling clock frequency FSC and the specific frequency band FINW.

FINW=FIN1 to FIN2FSHW=FSHWM+FSHWP FSHWM=(FSC−FIN2) to (FSC−FIN1)

The frequency band sum FINP is cut off by the downstream switched capacitor unit and is not used. The sampling clock frequency FSC is typically set to the center frequency of the specific frequency band FINW.

FSC=(FIN1−FIN2)/2FSHWM=−(FIN2−FIN1)/2 to (FIN2−FIN1)/2

The difference frequency band FSHWM thus converts the center frequency of the specific frequency band FINW of the buffered signals S16P and S17P to 0, and inverts the order of the frequency components from minimum-to-maximum to maximum-to-minimum.

In a typical application the high frequency switches 16 and 17 are rendered using NMOS (negative channel metal oxide semiconductor) transistors. The high frequency switches 16 and 17 sample the buffered signals S16P and S17P input to the respective drains at the sampling clock signals S16R and S17R input to the gates, and output the sample hold signals S16Q and S17Q from the sources.

The capacitances 18 and 19 hold the samples of the signals sampled by the high frequency switches 16 and 17 for a predetermined time, and then output the sample hold signals S16Q and S17Q.

The switched capacitor unit includes switched capacitor filters 120 and 121. The switched capacitor unit limits the frequency band of the channel B and C sample hold signals S16Q and S17Q, and outputs the limited sample hold signals S120 and S121 from output pins P4 and P5. In a typical application the switched capacitor unit cuts off the sum frequency band ((FSC+FIN1) to (FSC+FIN2)), and passes the difference frequency band ((FSC−FIN2) to (FSC−FIN1)).

The sampling receiver according to this first embodiment of the invention thus includes an amplifier unit, a buffer unit, a sampling unit, and a switched capacitor unit, and amplifies and samples the high frequency signal SP1 to generate limited sample hold signals S120 and S121 converted to a low frequency band.

The sampling unit causes an impedance variation on channels B and C, and thus produces a distortion component and noise component, as it switches on and off while sampling.

The serial buffer unit absorbs impedance variation caused by the sampling operation of the sampling unit. As a result, variation in the amplified signals S70P and S70Q is suppressed, and the level of the sample hold signals S16Q and S17Q is stabilized. The serial buffer unit and parallel buffer unit 13 impedance match the amplified signals S70P and S70Q. As a result, the power of the amplified signals S70P and S70Q is maximized and sample hold signals S16Q and S17Q with a high signal-to-noise ratio (SNR) are generated.

The parallel buffer unit 13 also suppresses extraneous high frequencies above the specific frequency band to be received in the amplified signals S70P and S70Q, and reduces distortion and noise from the sampling operation of the sampling unit. As a result, the level of the sample hold signals S16Q and S17Q is precisely controlled and the SNR is increased.

The buffer unit is composed of from a few to more than ten passive devices, and the area ratio of the buffer unit is small even when the entire sampling receiver according to this embodiment of the invention is integrated into a single semiconductor circuit or rendered as a module on the circuit board. In addition, the sampling receiver according to this first embodiment of the invention provides the significant effect described above at a minimal increase in cost.

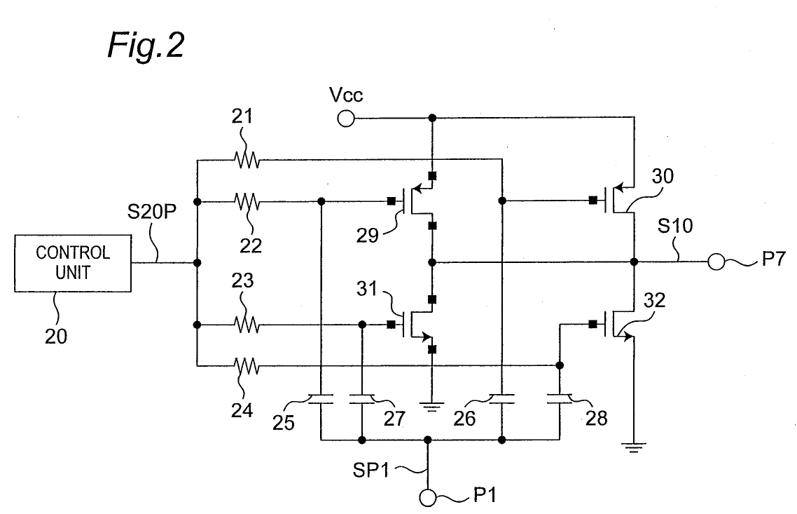

FIG. 2 is a circuit diagram of the amplifier circuit 10 in the first embodiment of the invention.

As shown in FIG. 2, the input pin P1 is connected in series directly to each of a first capacitance 25, second capacitance 26, third capacitance 27, and fourth capacitance 28. The first and second capacitances are respectively connected to the gates of p-channel FETs 29 and 30, and the third and fourth capacitances are respectively connected to the gates of n-channel FETs 31 and 32. A control unit 20 is connected through resistances 21 and 22 to the gates of p-channel FETs 29 and 30, and the control unit 20 is also connected through resistances 23 and 24 to the gates of n-channel FETs 31 and 32.

When a low signal is applied from the control unit 20 is input through resistances 21 and 22 to the gates of p-channel FETs 29 and 30, and supply voltage Vcc is applied to the sources of p-channel FETs 29 and 30, p-channel FETs 29 and 30 turn on. The drains of the p-channel FETs 29 and 30 are cascade connected and provide an amplification function. The outputs are connected by a line to pin P7.

When a low gate voltage is applied through resistances 23 and 24 to the n-channel FETs 31 and 32 and the source goes to ground and goes low, n-channel FETs 31 and 32 turn off and the output signal flows to P7.

When a high signal is applied from the control unit 20 through the resistances 21 and 22 to the gates of p-channel FETs 29 and 30, and supply voltage Vcc is applied to the sources of p-channel FETs 29 and 30, the p-channel FETs 29 and 30 turn off.

When a high gate voltage is applied through the resistances 23 and 24 to the n-channel FETs 31 and 32, and the source voltage goes to ground and goes low, the n-channel FETs 31 and 32 turn on and a high frequency signal flows from P7 to GND through the drains of n-channel FETs 31 and 32.

As a result, the amplifier circuit 10 converts the voltage of high frequency signal SP1 to current, and generates amplified output signal S10.

The output signal is connected in series to the resistances 11 and 12 shown in FIG. 1. The resistances 11 and 12 suppress load fluctuation produced by the amplifier circuit 10 as a result of the switching operation of the high frequency switches 16 and 17. An RC filter 13 is parallel connected between the resistances 11 and 12 and high frequency switches 16 and 17. The resistance 14 and capacitance 15 are parallel connected in the RC filter 13, which filters the harmonic output of the high frequency switches 16 and 17 and provides in-bandwidth matching. An increase in device size is also avoided by limiting the number of components used.

Input pins P2 and P3 for inputting high frequency signals are also connected to the gates of the high frequency switches 16 and 17, respectively. When the high frequency signal output from the amplifier circuit 10 is input to the drains of the high frequency switches 16 and 17, and high frequency signals from P2 and P3 are input to the gates of the high frequency switches 16 and 17, a frequency converted signal is output from the sources of the high frequency switches 16 and 17.

Capacitances 18 and 19 are parallel connected to the high frequency switches 16 and 17 on the downstream side, rendering a switched capacitance circuit that functions as an RC filter at the on resistance and capacitance of the high frequency switches 16 and 17, and operates as a filter after frequency conversion to reduce harmonic distortion. The high frequency switches 16 and 17 are also connected to the switched capacitor filters 120 and 121 and thus to the output pins P4 and P5.

### Embodiment 2

This second embodiment of the invention is described next primarily with reference to the differences between this second embodiment and the first embodiment. Other aspects of the configuration, operation, and effect of this embodiment are the same as the first embodiment, and further description thereof is omitted.

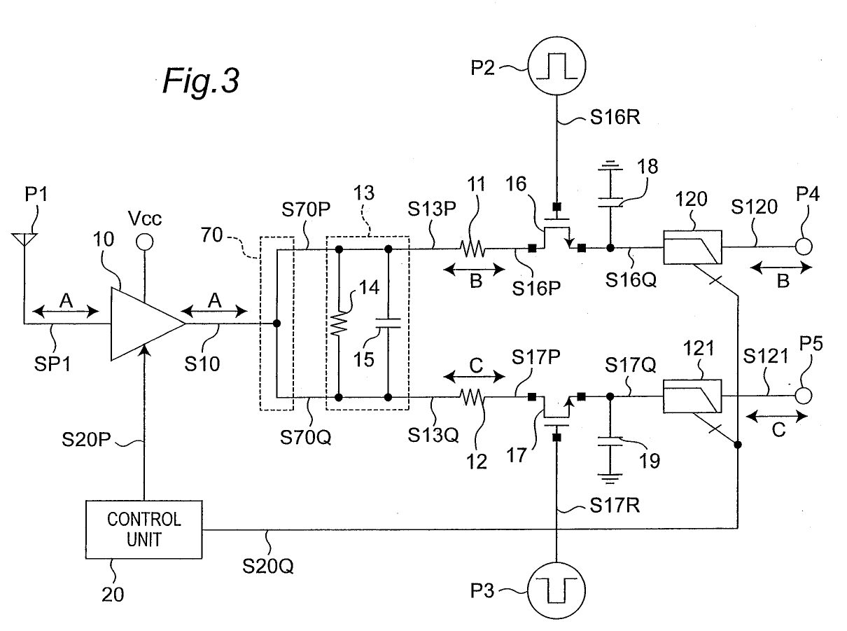

FIG. 3 is a circuit diagram of a sampling receiver according to a second embodiment of the invention.

In the sampling receiver according to this second embodiment of the invention the amplifier circuit 10 is connected to an input pin P1 to which a high frequency switch is input, and the RC filter 13 is parallel connected between the amplifier circuit 10 and the resistances 11 and 12 connected in series to the output of the amplifier circuit 10. The RC filter 13 thus filters harmonic output from the amplifier circuit 10, and suppresses harmonics.

The resistances 11 and 12 also suppress load variation on the amplifier circuit 10 caused by the switching operations of the high frequency switches 16 and 17. Input pins P2 and P3 for inputting high frequency signals are also connected to the gates of the high frequency switches 16 and 17, respectively.

When a high frequency signal output from the amplifier circuit 10 is input from the drain, and a high frequency signal is also input from the high frequency switches 16 and 17, a frequency converted signal is output from the sources of the high frequency switches 16 and 17.

Capacitances 18 and 19 are parallel connected to the high frequency switches 16 and 17 on the downstream side, rendering switched capacitor circuit that functions as an RC filter at the on resistance and capacitance of the high frequency switches 16 and 17, and operates as a filter after frequency conversion to reduce harmonic distortion. The high frequency switches 16 and 17 are also connected to the switched capacitor filters 120 and 121 and thus to the output pins P4 and P5.

The embodiment shown in FIG. 3 is described next from a different perspective. The configuration shown in FIG. 3 reverses the order of the parallel buffer unit 13 and the serial buffer unit including the resistances 11 and 12 in the buffer unit from the configuration shown in FIG. 1. More specifically, the parallel buffer unit 13 is connected to the amplifier unit on the downstream side, and the serial buffer unit including resistances 11 and 12 is connected on the downstream side of the parallel buffer unit 13.

This second embodiment of the invention achieves the same effect as the first embodiment. More specifically, the parallel buffer unit 13 impedance matches the amplified signals S70P and S70Q. As a result, the power of the amplified signals S70P and S70Q is maximized, and sample hold signals S16Q and S17Q with a high SNR are output.

The parallel buffer unit 13 also suppresses extraneous high frequencies above the specific frequency band to be received in the amplified signals S70P and S70Q, and reduces distortion and noise from the sampling operation of the sampling unit. As a result, the level of the sample hold signals S16Q and S17Q is precisely controlled and the SNR is increased.

The serial buffer unit including the resistances 11 and 12 absorbs impedance variation caused by the sampling operation of the sampling unit. As a result, variation in the amplified signals S70P and S70Q is suppressed, and the level of the sample hold signals S16Q and S17Q is stabilized.

### Embodiment 3

This third embodiment of the invention is described next primarily with reference to the differences between this embodiment and the foregoing embodiments. Other aspects of the configuration, operation, and effect of this embodiment are the same as the foregoing embodiment, and further description thereof is omitted.

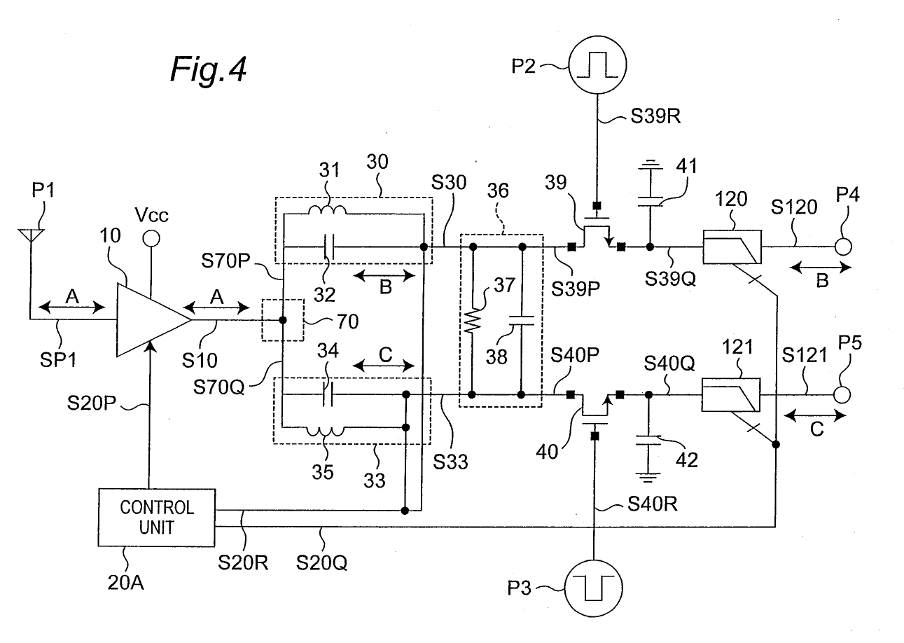

FIG. 4 is a circuit diagram of a sampling receiver according to a third embodiment of the invention.

In the sampling receiver according to this third embodiment of the invention the amplifier circuit 10 is connected to an input pin P1 to which a high frequency switch is input. The output stage of the amplifier circuit 10 then splits to serial parallel connected LC filters 30 and 33, which include capacitances 32 and 34 and inductors 31 and 35. Load fluctuation in the amplifier circuit that is produced by the switching operation of the high frequency switches 39 and 40 can be suppressed by the parasitic resistance component of the inductors 31 and 35. The LC filters 30 and 33 filter the harmonic output of the amplifier circuit 10 and can thus suppress harmonics. The high frequency switches 39 and 40 are connected downstream from the LC filters 30 and 33, and an RC filter 36 composed of a resistance 37 and a capacitance 38 is parallel connected between the LC filters 30 and 33 and high frequency switches 39 and 40. The RC filter 36 can suppress harmonics produced by the switching operation of the high frequency switches 39 and 40.

When the high frequency signal output from the amplifier circuit 10 is input to the drains of the high frequency switches 39 and 40, and a high frequency signal is also input from P2 and P3 to the gates of the high frequency switches 39 and 40, frequency converted signals are output from the source of high frequency switches 39 and 40.

Capacitances 41 and 42 are parallel connected downstream from the high frequency switches 39 and 40, forming a switched capacitor circuit that functions as an RC filter at the on resistance and capacitance of the high frequency switches 39 and 40, and operates as a filter after frequency conversion to reduce harmonic distortion. The high frequency switches 39 and 40 are also connected to the switched capacitor filters 120 and 121 and thus to the output pins P4 and P5.

The embodiment shown in FIG. 4 is described next from a different perspective.

The configuration shown in FIG. 3 changes the configuration of the serial buffer unit and changes the configuration of the control unit 20 from the configuration shown in FIG. 1 to supply power to the sampling unit. More specifically, the serial buffer unit in FIG. 4 includes a secondary serial buffer unit 30 and secondary serial buffer unit 33. The one secondary serial buffer unit 30 is a circuit composed of an inductor 31 and a parallel connected capacitance 32, and the other secondary serial buffer unit 33 is a circuit composed of an inductor 35 and a parallel connected capacitance 34. The resonance frequency of the secondary serial buffer units 30 and 33 is set in a typical application to a frequency higher than the specific frequency band to be received in the amplified signals S70P and S70Q.

The secondary serial buffer units 30 and 33 are each inserted in series to channels B and C, and output serial buffer signals S30 and S33, respectively, based on the amplified signals S70P and S70Q.

The parallel buffer unit 36 outputs buffer signals S39P and S40P based on the serial buffer signals S30 and S33.

The control unit 20A supplies power to the sampling unit, produces the power supply control signal S20R that controls switching the power supply on and off, and adds the power supply control signal S20R to the serial buffer signals S30 and S33. The control unit 20A thus turns the power of the high frequency switches 39 and 40 on and off by the buffer signals S39P and S40P.

This third embodiment of the invention can achieve the same effect as the embodiments described above. More particularly, the serial buffer unit absorbs impedance variation caused by the sampling operation of the sampling unit by the parasitic resistance contained in inductances 31 and 35. As a result, variation in the amplified signals S70P and S70Q is suppressed, and the level of the sample hold signals S39Q and S40Q is stabilized. The serial buffer unit and parallel buffer unit 36 impedance match the amplified signals S70P and S70Q. As a result, the power of the amplified signals S70P and S70Q is maximized and sample hold signals S39Q and S40Q with a high SNR are generated. The serial buffer unit and parallel buffer unit 36 also suppress extraneous high frequencies above the specific frequency band to be received in the amplified signals S70P and S70Q, and reduce distortion and noise from the sampling operation of the sampling unit. As a result, the level of the sample hold signals S39Q and S40Q is precisely controlled and the SNR is increased.

### Variation of the Third Embodiment

A variation of the third embodiment of the invention is described next primarily with reference to the differences between this embodiment and the third embodiment described above. Other aspects of the configuration, operation, and effect of this embodiment are the same as the third embodiment, and further description thereof is omitted.

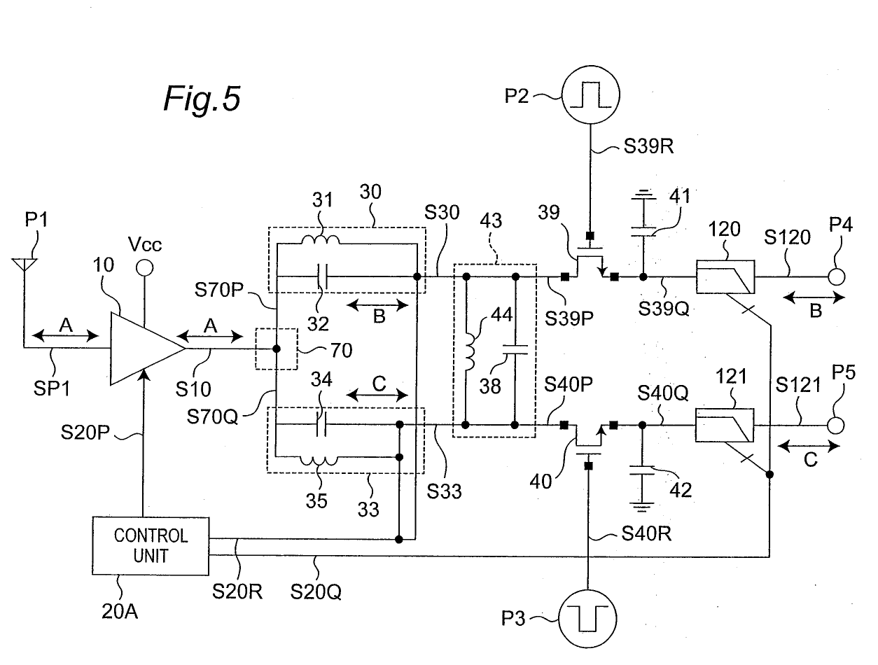

FIG. 5 is a circuit diagram of a sampling receiver according to a variation of the third embodiment of the invention.

In the sampling receiver according to this variation of the third embodiment of the invention the amplifier circuit 10 is connected to an input pin P1 to which a high frequency switch is input. The output stage of the amplifier circuit 10 then splits to serial parallel connected LC filters 30 and 33, which include capacitances 32 and 34 and inductors 31 and 35.

The LC filters 30 and 33 filter the harmonic output of the amplifier circuit 10 and can thus suppress these harmonics. The high frequency switches 39 and 40 are connected downstream from the LC filters 30 and 33, and an LC filter 43 composed of an inductor 44 and a capacitance 38 is parallel connected between the LC filters 31 and 33 and high frequency switches 39 and 40. This configuration suppresses harmonics produced by the switching operation of the high frequency switches 39 and 40.

The embodiment shown in FIG. 5 is described next from a different perspective.

The configuration shown in FIG. 5 changes the configuration of the parallel buffer unit in the configuration shown in FIG. 4. More specifically, in FIG. 5 the parallel buffer unit 43 includes an inductor 44 and a capacitance 38. The resonance frequency of the parallel buffer unit 43 is set in a typical application to a frequency higher than the specific frequency band to be received in the amplified signals S70P and S70Q.

This variation of the third embodiment of the invention can achieve the same effect as the third embodiment described above. More particularly, the serial buffer unit including secondary serial buffer unit 30 and secondary serial buffer unit 33 and the parallel buffer unit 43 impedance match the amplified signals S70P and S70Q. As a result, the power of the amplified signals S70P and S70Q is maximized and sample hold signals S39Q and S40Q with a high SNR are generated. The serial buffer unit including secondary serial buffer unit 30 and secondary serial buffer unit 33 and the parallel buffer unit 43 also suppress extraneous high frequencies above the specific frequency band to be received in the amplified signals S70P and S70Q, and reduce distortion and noise from the sampling operation of the sampling unit. As a result, the level of the sample hold signals S39Q and S40Q is precisely controlled and the SNR is increased.

### Embodiment 4

This fourth embodiment of the invention is described next primarily with reference to the differences between this embodiment and the foregoing embodiments. Other aspects of the configuration, operation, and effect of this embodiment are the same as the foregoing embodiment, and further description thereof is omitted.

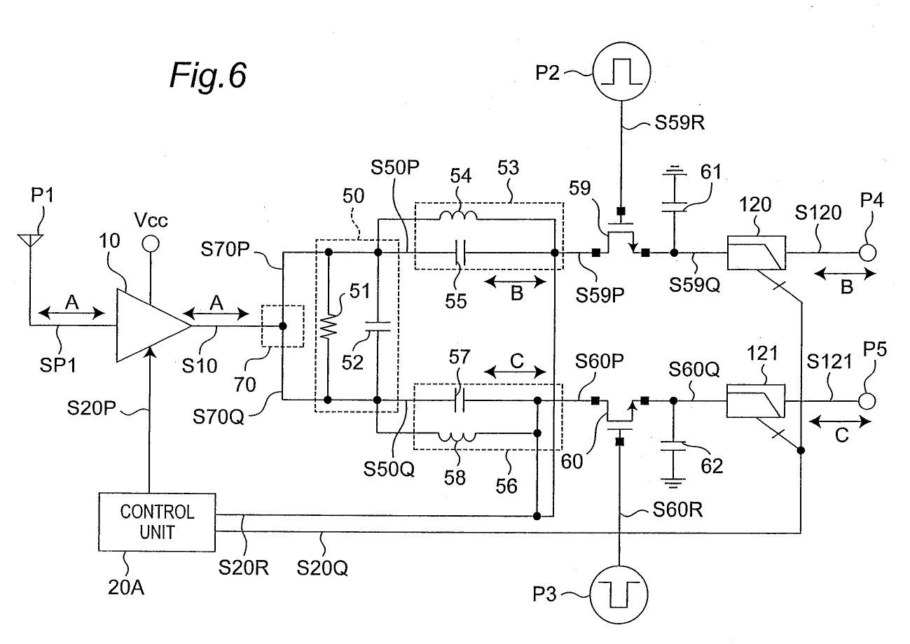

FIG. 6 is a circuit diagram of a sampling receiver according to a fourth embodiment of the invention.

In the sampling receiver according to this fourth embodiment of the invention the amplifier circuit 10 is connected to an input pin P1 to which a high frequency switch is input, and LC filters 53 and 56 are parallel connected downstream from the amplifier circuit 10. The LC filters 53 and 56 include inductors 54 and 58 and capacitances 55 and 57. Load fluctuation in the amplifier circuit that is produced by the switching operation of the high frequency switches 59 and 60 can be suppressed by the parasitic resistance component of the inductors 54 and 58.

An RC filter 50 is parallel connected between the LC filters 53 and 56 parallel connected to the amplifier circuit 10. The RC filter 50 has a resistance 51 and a capacitance 52, filters harmonic output from the amplifier circuit 10 and thus suppresses harmonics.

The high frequency switches 59 and 60 are connected downstream from the LC filters. Input pins P2 and P3 for inputting high frequency signals are connected to the gates of the high frequency switches 59 and 60, respectively.

When the high frequency signal output from the amplifier circuit 10 is input to the drains, and high frequency signals from P2 and P3 are input to the gates of the high frequency switches 59 and 60, a frequency converted signal is output from the sources of the high frequency switches 59 and 60.

Capacitances 61 and 62 are parallel connected to the high frequency switches 59 and 60 on the downstream side, rendering a switched capacitance circuit that functions as an RC filter at the on resistance and capacitance of the high frequency switches 59 and 60, and operates as a filter after frequency conversion to reduce harmonic distortion. The high frequency switches 59 and 60 are also connected to the switched capacitor filters 120 and 121 and thus to the output pins P4 and P5.

The embodiment shown in FIG. 6 is described next from a different perspective. The configuration shown in FIG. 6 reverses the order of the serial buffer unit and the parallel buffer unit 36 and associated components in the buffer unit from the configuration shown in FIG. 4, and adds the power supply control signal S20R directly to the buffer signals S59P and S60P.

More specifically, the serial buffer unit in FIG. 6 includes a secondary serial buffer unit 53 and secondary serial buffer unit 56. The one secondary serial buffer unit 30 is a circuit composed of an inductor 54 and a parallel connected capacitance 55, and the other secondary serial buffer unit 56 is a circuit composed of an inductor 58 and a parallel connected capacitance 57. The resonance frequency of the secondary serial buffer units 53 and 56 is set in a typical application to a frequency higher than the specific frequency band to be received in the amplified signals S70P and S70Q.

The parallel buffer unit 50 is connected on the downstream side of the amplifier unit, and the serial buffer unit is connected on the downstream side of the parallel buffer unit 50. The control unit 20A turns the power of the high frequency switches 59 and 60 on and off by the buffer signals S59P and S60P.

This fourth embodiment of the invention can achieve the same effect as the embodiments described above. More particularly, the parallel buffer unit 50 impedance matches the amplified signals S70P and S70Q. As a result, the power of the amplified signals S70P and S70Q is maximized and sample hold signals S59Q and S60Q with a high SNR are generated.

The serial buffer unit absorbs impedance variation caused by the sampling operation of the sampling unit by the parasitic resistance contained in inductances 54 and 58. As a result, variation in the amplified signals S70P and S70Q is suppressed, and the level of the sample hold signals S59Q and S60Q is stabilized.

The serial buffer unit and parallel buffer unit 50 also suppress extraneous high frequencies above the specific frequency band to be received in the amplified signals S70P and S70Q, and reduce distortion and noise from the sampling operation of the sampling unit. As a result, the level of the sample hold signals S59Q and S60Q is precisely controlled and the SNR is increased.

### Variation of the Fourth Embodiment

A variation of the fourth embodiment of the invention is described next primarily with reference to the differences between this embodiment and the fourth embodiment described above. Other aspects of the configuration, operation, and effect of this embodiment are the same as the fourth embodiment, and further description thereof is omitted.

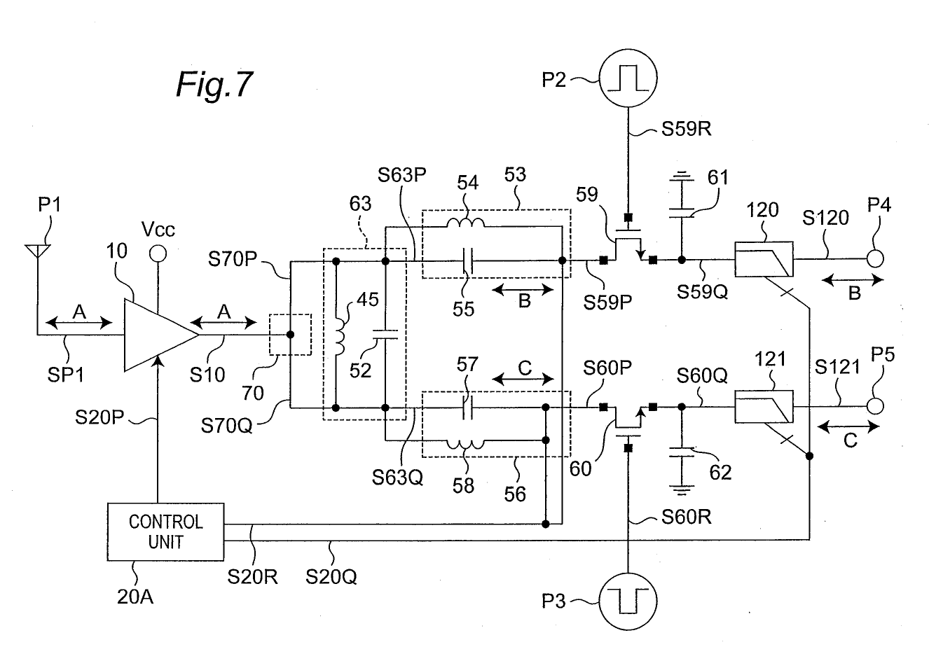

FIG. 7 is a circuit diagram of a sampling receiver according to a variation of the fourth embodiment of the invention.

In the sampling receiver according to this variation of the fourth embodiment of the invention the amplifier circuit 10 is connected to an input pin P1 to which a high frequency switch is input. The output stage of the amplifier circuit 10 then splits to serial parallel connected LC filters 53 and 56, which include capacitances 55 and 57 and inductors 54 and 58.

Load fluctuation in the amplifier circuit that is produced by the switching operation of the high frequency switches 59 and 60 can be suppressed by the parasitic resistance component of the inductors 54 and 58.

An LC filter 63 is parallel connected between the LC filters 53 and 56 serial parallel connected to the amplifier circuit 10. The LC filter 63 has an inductor 45 and capacitance 52, filters harmonic output from the amplifier circuit 10 and can thus suppress harmonics.

The embodiment shown in FIG. 7 is described next from a different perspective.

The configuration shown in FIG. 7 changes the configuration of the parallel buffer unit from the configuration shown in FIG. 6. More specifically, the parallel buffer unit 63 includes an inductor 45 and a capacitance 52. The resonance frequency of the parallel buffer unit 63 is set in a typical application to a frequency higher than the specific frequency band to be received in the amplified signals S70P and S70Q.

This variation of the fourth embodiment of the invention can achieve the same effect as the fourth embodiment described above. More particularly, the parallel buffer unit 63 impedance matches the amplified signals S70P and S70Q. As a result, the power of the amplified signals S70P and S70Q is maximized and sample hold signals S59Q and S60Q with a high SNR are generated.

The serial buffer unit and parallel buffer unit 63 also suppress extraneous high frequencies above the specific frequency band to be received in the amplified signals S70P and S70Q, and reduce distortion and noise from the sampling operation of the sampling unit. As a result, the level of the sample hold signals S59Q and S60Q is precisely controlled and the SNR is increased.

### Embodiment 5

This fifth embodiment of the invention is described next primarily with reference to the differences between this embodiment and the foregoing embodiments. Other aspects of the configuration, operation, and effect of this embodiment are the same as the foregoing embodiment, and further description thereof is omitted.

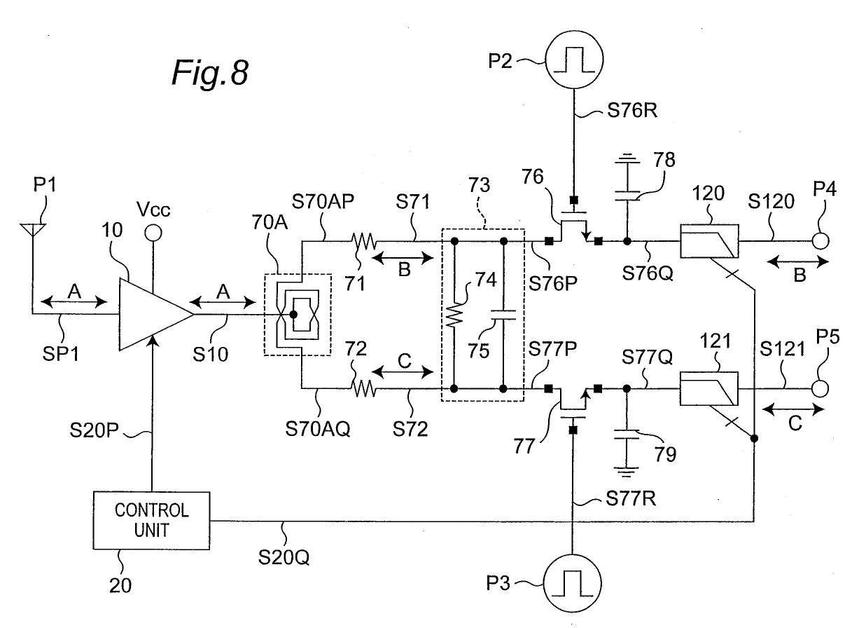

FIG. 8 is a circuit diagram of a sampling receiver according to a fifth embodiment of the invention.

In the sampling receiver according to this fifth embodiment of the invention the amplifier circuit 10 is connected to an input pin P1 to which a high frequency switch is input. A differential inductor 70A is connected in series to the output of the amplifier circuit 10 and is differentially wired to resistances 71 and 72 serially connected downstream. An RC filter 73 is parallel connected between these resistances and downstream high frequency switches 76 and 77. The RC filter 73 has a resistance 74 and a capacitance 75.

The input pins P2 and P3 for inputting high frequency signals are connected to the gates of the high frequency switches 76 and 77. Capacitances 78 and 79 are parallel connected downstream from the high frequency switches 76 and 77, forming a switched capacitor circuit. The high frequency switches 76 and 77 are also connected to the switched capacitor filters 120 and 121 and thus to the output pins P4 and P5.

The embodiment shown in FIG. 8 is described next from a different perspective.

The configuration shown in FIG. 8 changes the branching circuit 70 in the configuration shown in FIG. 1 to a differential conversion circuit 70A. More specifically, in FIG. 8 the amplifier unit includes the amplifier circuit 10 and differential conversion circuit 70A. The amplifier unit amplifies the high frequency signal SP1 on one channel A from the input pin P1, and outputs amplified signals S70AP and S70AQ on two channels B and C. Based on the amplified output signal S10 on channel A, the differential conversion circuit 70A outputs amplified signals S70AP and S70AQ on channels B and C with substantially equal amplitude and frequency and a 180° phase difference.

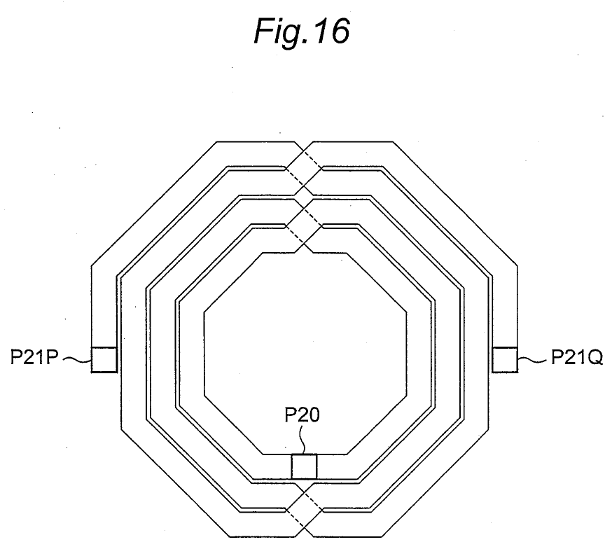

In a typical application this fifth embodiment uses a differential inductor as the differential conversion circuit 70A. FIG. 16 shows an example of a differential inductor. With the differential inductor shown in FIG. 16 the amplified output signal S10 is input to pin P20, and the amplified signals S70AP and S70AQ are output from pins P21P and P21Q, respectively.

In the configuration shown in FIG. 1, the sampling clock signals S16R and S17R are opposite phase. With the configuration shown in FIG. 8, however, the amplified signals S70AP and S70AQ are opposite phase, and the sampling clock signals S76R and S77R are therefore same phase.

This fifth embodiment of the invention achieves the same effect as the first embodiment.

More specifically, the serial buffer unit including resistances 71 and 72 absorbs impedance variation caused by the sampling operation of the sampling unit. As a result, variation in the amplified signals S70AP and S70AQ is suppressed, and the level of the sample hold signals S76Q and S77Q is stabilized. The serial buffer unit including resistances 71 and 72 and parallel buffer unit 73 impedance match the amplified signals S70AP and S70AQ. As a result, the power of the amplified signals S70AP and S70AQ is maximized and sample hold signals S76Q and S77Q with a high SNR are generated.

The parallel buffer unit 73 also suppresses extraneous high frequencies above the specific frequency band to be received in the amplified signals S70AP and S70AQ, and reduces distortion and noise from the sampling operation of the sampling unit. As a result, the level of the sample hold signals S76Q and S77Q is precisely controlled and the SNR is increased.

### First Variation of the Fifth Embodiment

A first variation of the fifth embodiment of the invention is described next primarily with reference to the differences between this embodiment and the fifth embodiment described above. Other aspects of the configuration, operation, and effect of this embodiment are the same as the fifth embodiment, and further description thereof is omitted.

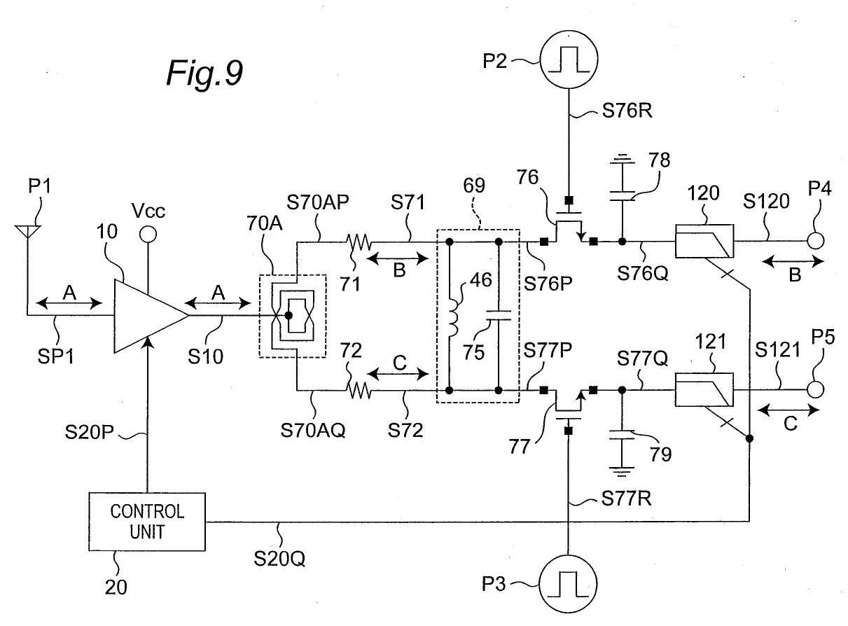

FIG. 9 is a circuit diagram of a sampling receiver according to a first variation of the fifth embodiment of the invention.

In the sampling receiver according to this embodiment of the invention the amplifier circuit 10 is connected to an input pin P1 to which a high frequency switch is input. A differential inductor 70A is connected in series to the output of the amplifier circuit 10 and is differentially wired to resistances 71 and 72 serially connected downstream. An LC filter 69 is parallel connected between these resistances and downstream high frequency switches 76 and 77. The LC filter 69 has an inductor 46 and a capacitance 75.

The input pins P2 and P3 for inputting high frequency signals are connected to the gates of the high frequency switches 76 and 77. Capacitances 78 and 79 are parallel connected downstream from the high frequency switches 76 and 77, forming a switched capacitor circuit. The high frequency switches 76 and 77 are also connected to the switched capacitor filters 120 and 121 and thus to the output pins P4 and P5.

The embodiment shown in FIG. 9 is described next from a different perspective.

The configuration shown in FIG. 9 differs from FIG. 8 in the configuration of the parallel buffer unit. More specifically, in FIG. 9 the parallel buffer unit 69 includes an inductor 46 and a capacitance 75. The resonance frequency of the LC filter 69 is set in a typical application to a frequency higher than the specific frequency band to be received in the amplified signals S70AP and S70AQ.

This first variation of the fifth embodiment of the invention achieves the same effect as the fifth embodiment.

More specifically, the serial buffer unit including resistances 71 and 72 and the parallel buffer unit 69 absorb impedance match the amplified signals S70AP and S70AQ. As a result, the power of the amplified signals S70AP and S70AQ is maximized and sample hold signals S76Q and S77Q with a high SNR are generated.

The parallel buffer unit 69 also suppresses extraneous high frequencies above the specific frequency band to be received in the amplified signals S70AP and S70AQ, and reduces distortion and noise from the sampling operation of the sampling unit. As a result, the level of the sample hold signals S76Q and S77Q is precisely controlled and the SNR is increased.

### Second Variation of the Fifth Embodiment

A second variation of the fifth embodiment of the invention is described next primarily with reference to the differences between this embodiment and the fifth embodiment and first variation of the fifth embodiment described above. Other aspects of the configuration, operation, and effect of this embodiment are the same as the fifth embodiment and first variation of the fifth embodiment, and further description thereof is omitted.

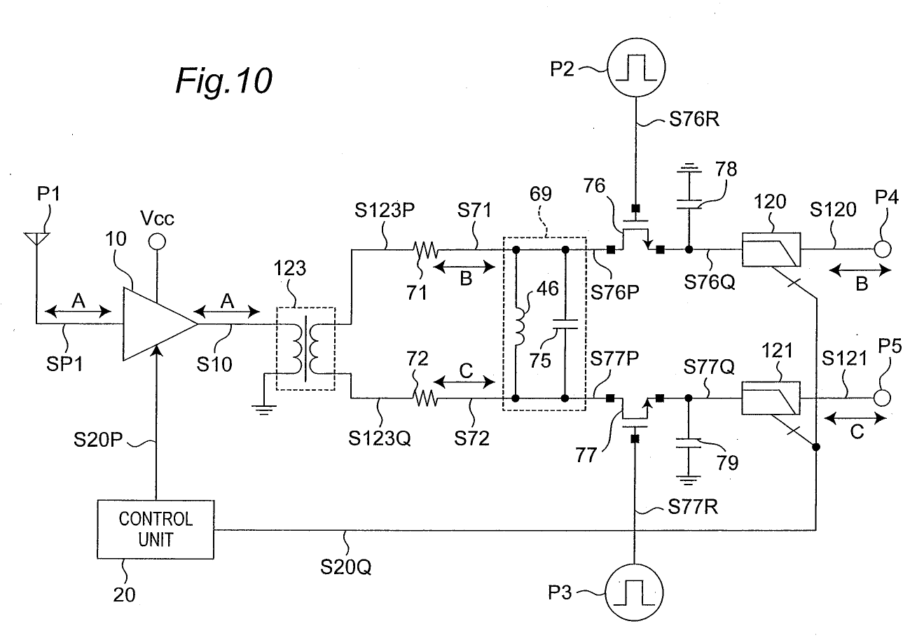

FIG. 10 is a circuit diagram of a sampling receiver according to a second variation of the fifth embodiment of the invention.

In the sampling receiver according to this embodiment of the invention the amplifier circuit 10 is connected to an input pin P1 to which a high frequency switch is input. A differential conversion circuit 123 is connected in series to the output of the amplifier circuit 10 and is differentially wired to resistances 71 and 72 serially connected downstream. An LC filter 69 is parallel connected between these resistances and downstream high frequency switches 76 and 77. The LC filter 69 has an inductor 46 and a capacitance 75.

The input pins P2 and P3 for inputting high frequency signals are connected to the gates of the high frequency switches 76 and 77. Capacitances 78 and 79 are parallel connected downstream from the high frequency switches 76 and 77, forming a switched capacitor circuit. The high frequency switches 76 and 77 are also connected to the switched capacitor filters 120 and 121 and thus to the output pins P4 and P5.

The embodiment shown in FIG. 10 is described next from a different perspective.

The configuration shown in FIG. 10 differs from FIG. 9 in that the differential conversion circuit 70A is changed to differential conversion circuit 123. More specifically, in FIG. 10 the amplifier unit includes the amplifier circuit 10 and differential conversion circuit 123. The amplifier unit amplifies the high frequency signal SP1 on one channel A from the input pin P1, and outputs amplified signals S70AP and S70AQ on two channels B and C. Based on the amplified output signal S10 on channel A, the differential conversion circuit 123 outputs amplified signals S123P and S123Q on channels B and C with substantially equal amplitude and frequency and a 180° phase difference.

This embodiment of the invention uses a differential transformer that converts a primary power supply on one channel to a secondary power supply on two channels of mutually opposite phase as the differential conversion circuit 123. Similarly to the configuration shown in FIG. 9, sampling clock signals S76R and S77R are also same phase in the configuration shown in FIG. 10.

This second variation of the fifth embodiment achieves the same effect as the first variation of the fifth embodiment described above.

### Embodiment 6

This sixth embodiment of the invention is described next primarily with reference to the differences between this embodiment and the foregoing embodiments. Other aspects of the configuration, operation, and effect of this embodiment are the same as the foregoing embodiment, and further description thereof is omitted.

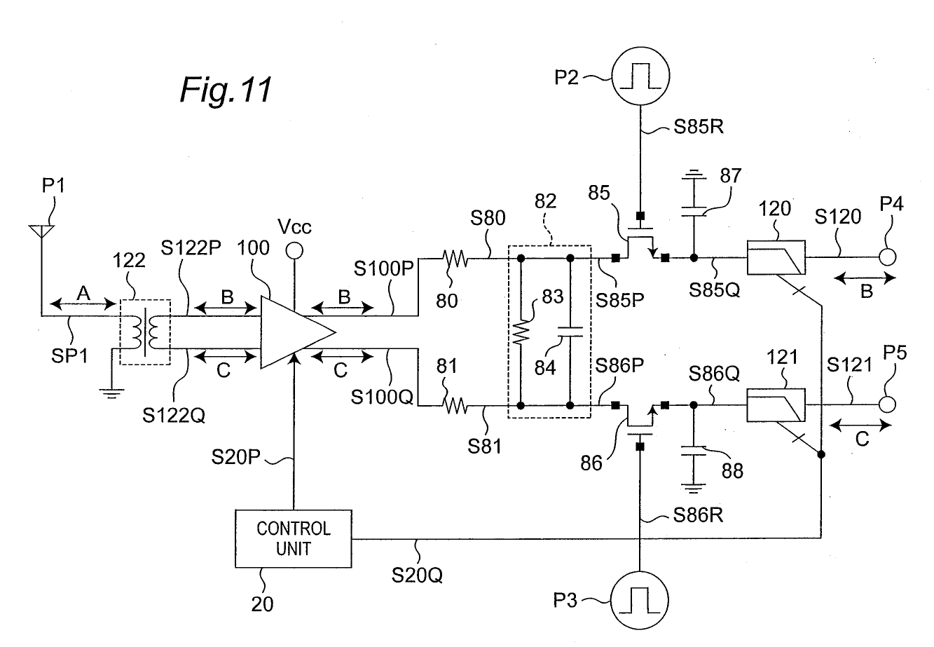

FIG. 11 is a circuit diagram of a sampling receiver according to a sixth embodiment of the invention.

The sampling receiver according to this sixth embodiment of the invention includes a differential conversion circuit 122 for differential conversion from the same phase as the high frequency signal input from the input pin P1. The differential conversion circuit 122 is connected to the amplifier circuit 100, and the amplifier circuit 100 produces differential output. Resistances 80 and 81 are connected downstream from the amplifier circuit 100 output, and high frequency switches 85 and 86 are connected in series downstream from the resistances 80 and 81.

An RC filter 82 is parallel connected between the resistances 80 and 81 and the high frequency switches 85 and 86. The RC filter 82 includes a resistance 83 and a capacitance 84. The RC filter 82 reduces harmonics by filtering the harmonic output of the high frequency switches 85 and 86, and provides in-bandwidth matching. An increase in device size is also avoided by limiting the number of components used.

The input pins P2 and P3 for inputting high frequency signals are connected to the gates of the high frequency switches 85 and 86. Capacitances 87 and 88 are parallel connected downstream from the high frequency switches 85 and 86, forming a switched capacitor circuit. The high frequency switches 85 and 86 are also connected to the switched capacitor filters 120 and 121 and thus to the output pins P4 and P5.

The resistances 80 and 81 connected in series to the output of the amplifier circuit 100 are connected to suppress load variation on the amplifier circuit 100 caused by the switching operations of the high frequency switches 85 and 86. The resistance 83 and capacitance 84 are parallel connected in the RC filter 82, filter the harmonic output of the high frequency switches 85 and 86, and provides in-bandwidth matching.

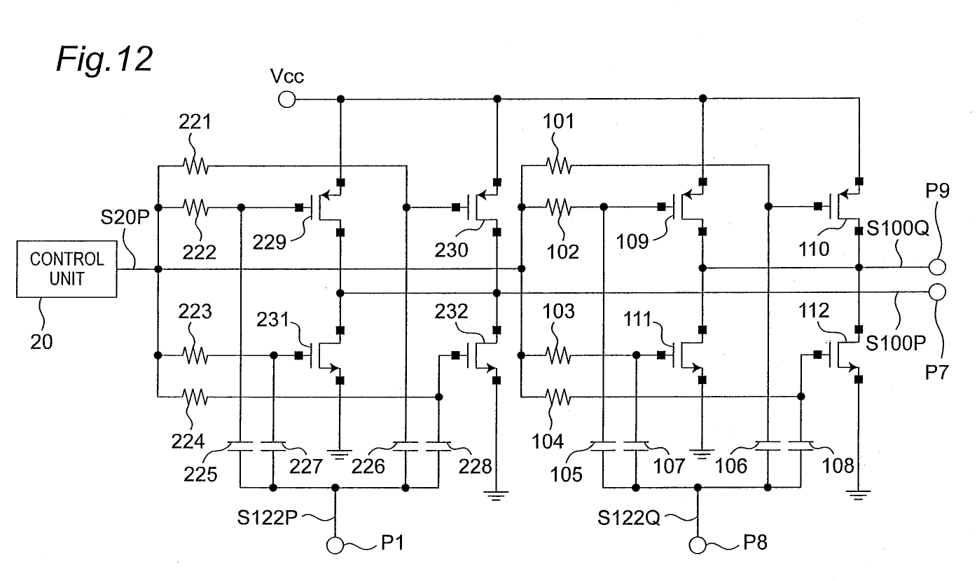

FIG. 12 is a circuit diagram of the amplifier circuit in the sixth embodiment of the invention. The amplifier circuit 100 shown in FIG. 12 adds differential circuit elements to the circuit design of the amplifier circuit 10 shown in FIG. 2 according to the first embodiment of the invention. The differential conversion circuit 122 generates a differential signal by differential conversion from the same phase, and outputs to input pins P1 and P8. Parts that are the same as shown in FIG. 2 are identified by the same reference numerals in FIG. 12, and further description thereof is omitted.

The output signals are serially connected to the resistances 80 and 81 shown in FIG. 11. The resistances 80 and 81 suppress load variation on the amplifier circuit 100 caused by the switching operations of the high frequency switches 85 and 86.

An RC filter 82 is parallel connected between the resistances 80 and 81 and the high frequency switches 85 and 86. The RC filter 82 includes a resistance 83 and a capacitance 84. The RC filter 82 filters harmonics from the high frequency switches 85 and 86, and provides in-bandwidth matching.

The input pins P2 and P3 for inputting high frequency signals are connected to the gates of the high frequency switches 85 and 86. When the high frequency signals output from the amplifier circuit 100 are input from the drains of the high frequency switches 85 and 86, and high frequency signals are input to the gates of the high frequency switches 85 and 86 from the input pins P2 and P3, frequency converted signals are output from the sources of the high frequency switches 85 and 86.

Capacitances 87 and 88 are parallel connected downstream from the high frequency switches 85 and 86, forming a switched capacitor circuit that functions as an RC filter at the on resistance and capacitance of the high frequency switches 85 and 86, and operates as a filter after frequency conversion to reduce harmonic distortion. The high frequency switches 85 and 86 are also connected to the switched capacitor filters 120 and 121 and thus to the output pins P4 and P5.

The configuration shown in FIG. 11 is described next from a different perspective.

The configuration shown in FIG. 11 changes the configuration of the amplifier unit shown in FIG. 1. More specifically, in FIG. 11 the amplifier unit includes the differential conversion circuit 122 and amplifier circuit 100. The amplifier unit amplifies a high frequency signal SP1 on one channel A from the input pin P1, and outputs amplified signals S100P and S100Q on two channels B and C. Based on the high frequency signal SP1, the differential conversion circuit 122 outputs amplified signals S122P and S122Q on channels B and C with substantially equal amplitude and frequency and a 180° phase difference. The differential conversion circuit 122 in this sixth embodiment of the invention is a differential transformer that converts a primary power supply on one channel to a secondary power supply on two channels of mutually opposite phase.

The amplifier circuit 100 amplifies the two channel amplified signals S122P and S122Q and outputs opposite-phase amplified signals S100P and S100Q on two channels.

The amplifier circuit 100 is a differential amplifier circuit that amplifies differential input signals S122P and S122Q and outputs differential output signals S100P and S100Q. In a typical application as shown in FIG. 12, the amplifier circuit 100 converts the voltage of differential inputs S122P and S122Q to current, and outputs differential output signals S100P and S100Q.

Similarly to the configuration shown in FIG. 9, sampling clock signals S85R and S86R are also same phase in the configuration shown in FIG. 11.

This sixth embodiment of the invention has the same effect as the first embodiment of the invention. In addition, by using a differential amplifier circuit for the amplifier circuit 100, same-phase interference from external noise, for example, at the amplifier unit input can be cancelled, and the SNR of the differential output signals S100P and S100Q can be increased.

### Embodiment 7

This seventh embodiment of the invention is described next primarily with reference to the differences between this embodiment and the foregoing embodiments. Other aspects of the configuration, operation, and effect of this embodiment are the same as the foregoing embodiment, and further description thereof is omitted.

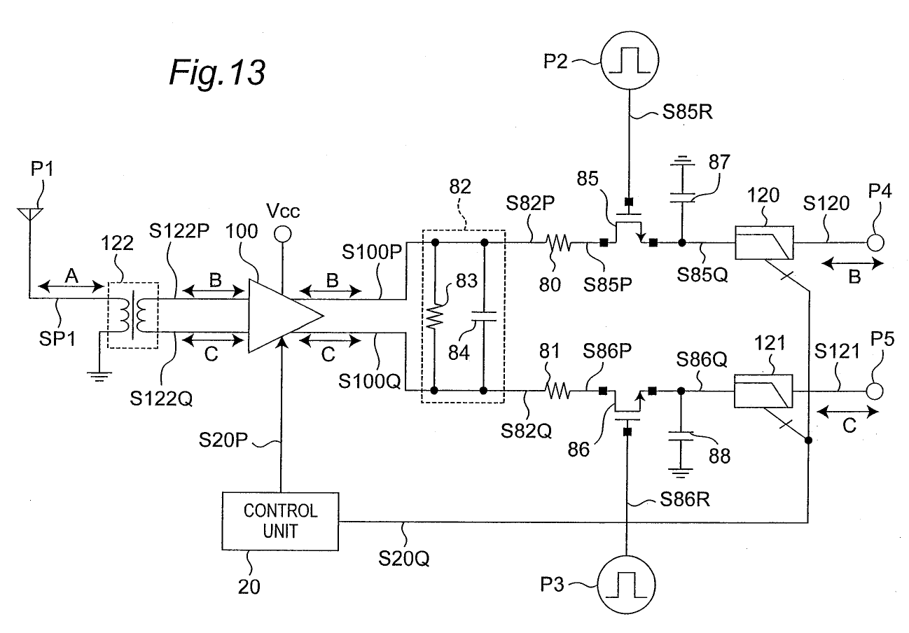

FIG. 13 is a circuit diagram of a sampling receiver according to a seventh embodiment of the invention.

The sampling receiver according to this seventh embodiment of the invention includes a differential conversion circuit 122 for differential conversion from the same phase as the high frequency signal input from the input pin P1. The differential conversion circuit 122 is connected to the amplifier circuit 100, and the amplifier circuit 100 produces differential output. Resistances 80 and 81 are connected downstream from the amplifier circuit 100 output, and the RC filter 82 is parallel connected between the amplifier circuit 100 and the resistances 80 and 81.

The RC filter 82 includes a resistance 83 and a capacitance 84. The RC filter 82 filters harmonics output from the amplifier circuit 100, and provides in-bandwidth matching. An increase in device size is also avoided by limiting the number of components used.

The resistances 80 and 81 suppress load variation on the amplifier circuit 100 caused by the switching operations of the high frequency switches 85 and 86. The input pins P2 and P3 for inputting high frequency signals are connected to the gates of the high frequency switches 85 and 86. When the high frequency signals output from the amplifier circuit 100 are input from the drains, and high frequency signals are input from the high frequency switches 85 and 86, frequency converted signals are output from the sources of the high frequency switches 85 and 86.

Capacitances 87 and 88 are parallel connected downstream from the high frequency switches 85 and 86, forming a switched capacitor circuit that functions as an RC filter at the on resistance and capacitance of the high frequency switches 85 and 86, and operates as a filter after frequency conversion to reduce harmonic distortion. The high frequency switches 85 and 86 are also connected to the switched capacitor filters 120 and 121 and thus to the output pins P4 and P5.

The configuration shown in FIG. 13 is described next from a different perspective.

The configuration shown in FIG. 13 changes the configuration of the amplifier unit shown in FIG. 3. More specifically, in FIG. 13 the amplifier unit amplifies a high frequency signal SP1 input on one channel A from the input pin P1, and outputs amplified signals S100P and S100Q on two channels B and C. Based on the high frequency signal SP1, the differential conversion circuit 122 outputs amplified signals S122P and S122Q on channels B and C with substantially equal amplitude and frequency and a 180° phase difference. The differential conversion circuit 122 in this seventh embodiment of the invention is a differential transformer that converts a primary power supply on one channel to a secondary power supply on two channels of mutually opposite phase.

The amplifier circuit 100 amplifies the two channel amplified signals S122P and S122Q and outputs opposite-phase amplified signals S100P and S100Q on two channels.

The amplifier circuit 100 is a differential amplifier circuit that amplifies differential input signals S122P and S122Q and outputs differential output signals S100P and S100Q. In a typical application as shown in FIG. 12, the amplifier circuit 100 converts the voltage of differential inputs S122P and S122Q to current, and outputs differential output signals S100P and S100Q.

Similarly to the configuration shown in FIG. 11, sampling clock signals S85R and S86R are also same phase in the configuration shown in FIG. 13.

This seventh embodiment of the invention has the same effect as the first embodiment of the invention. In addition, by using a differential amplifier circuit for the amplifier circuit 100, same-phase interference from external noise, for example, at the amplifier unit input can be cancelled, and the SNR of the differential output signals S100P and S100Q can be increased.

### Embodiment 8

This eighth embodiment of the invention is described next primarily with reference to the differences between this embodiment and the foregoing embodiments. Other aspects of the configuration, operation, and effect of this embodiment are the same as the foregoing embodiment, and further description thereof is omitted.

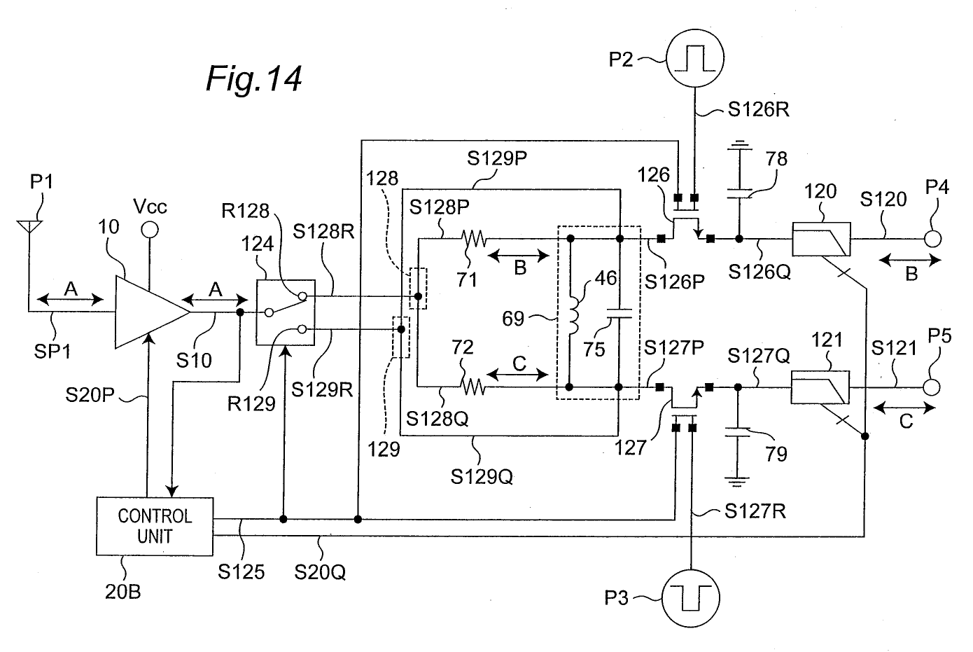

FIG. 14 is a circuit diagram of a sampling receiver according to an eighth embodiment of the invention.

In the sampling receiver according to this embodiment of the invention the amplifier circuit 10 is connected to the input pin P1 from which high frequency signals are input, and a switch unit 124 is connected to the output of the amplifier circuit 10. When the output level of the amplifier circuit 10 is high, the switch unit 124 switches to channel R128. When the output level of the amplifier circuit 10 is low, the switch unit 124 switches to channel R129.

When the switch unit 124 switches to channel R128, resistances 71 and 72 are connected in series downstream, and the load fluctuation of the amplifier circuit 10 caused by the switching operation of the high frequency switches 126 and 127 can be suppressed. The LC filter 69 filters harmonics produced by the amplifier circuit 10, and can thus suppress harmonic output.

When the switch unit 124 switches to channel R129, the LC filter 69 is connected. Because a resistance is not connected in series in this case, a drop in gain can be prevented and the signal can be passed without a rise in the SNR. Dual gate FETs 126 and 127 are connected downstream from the LC filter 69, and an amplitude level signal S125 denoting the amplitude level of the amplified output signal S10 is input to one gate to control the gain according to the output level of the amplifier circuit 10.

When the high frequency signals output from the amplifier circuit 10 are input from the drains of high frequency switches 126 and 127, and high frequency signals are input from the input pins P2 and P3 to the gates of the high frequency switches 126 and 127, frequency converted signals are output from the sources of the high frequency switches 126 and 127.

Capacitances 78 and 79 are parallel connected downstream from the high frequency switches 126 and 127, forming a switched capacitor circuit that functions as an RC filter at the on resistance and capacitance of the high frequency switches 126 and 127, and operates as a filter after frequency conversion to reduce harmonic distortion. The high frequency switches 126 and 127 are also connected to the switched capacitor filters 120 and 121 and thus to the output pins P4 and P5.

The configuration shown in FIG. 14 is described next from a different perspective.

The configuration shown in FIG. 14 changes the configuration shown in FIG. 1 by inserting the switch unit 124 between the amplifier circuit 10 and branching circuit 70 of the amplifier unit, and changing the configuration of the parallel buffer unit 69, high frequency switches 126 and 127, and the control unit 20.

More particularly, as shown in FIG. 14, the buffer unit includes a serial buffer unit composed of resistances 71 and 72, and a parallel buffer unit 69 having the inductor 46 and capacitance 75 connected parallel. The resonance frequency of the parallel buffer unit 69 is set in a typical application to a frequency higher than the specific frequency band to be received from the amplified output signal S10. The buffer unit includes a secondary buffer unit including the serial buffer unit, which is composed of the resistances 71 and 72, and the parallel buffer unit 69, and a secondary buffer unit composed of only the parallel buffer unit 69.

An amplitude level detection circuit detects the amplitude of the amplified output signal S10, and outputs amplitude level signal S125. The amplitude level detection circuit is included in the control unit 20B. The amplified output signal S10 on channel A is input to the switch unit 124, which selects either channel R128 or channel R129 based on the amplitude level signal S125, and outputs the amplified output signal S10 to the selected channel. In a typical application the switch unit 124 selects channel R128 when the amplitude level is greater than or equal to a predetermined level, and selects channel R129 when the amplitude level is less than this predetermined level.

The branching circuit 128 splits the amplified output signal S128R from the switch unit 124 into amplified signals S128P and S128Q of substantially equal amplitude, frequency, and phase on channels B and C.

The branching circuit 129 splits the amplified output signal S129R from the switch unit 124 into amplified signals S129P and S129Q of substantially equal amplitude, frequency, and phase on channels B and C.

The secondary buffer unit including the serial buffer unit and parallel buffer unit 69 generates buffered signals S126P and S127P on channels B and C based on amplified signals S128P and S128Q.

The secondary buffer unit including only the parallel buffer unit 69 generates buffered signals S126P and S127P on channels B and C based on amplified signals S129P and S129Q.

In a typical application the high frequency switches 126 and 127 are rendered using dual gate NMOS transistors each having two gates. The sampling clock signals S39R and S40R and amplitude level signal S125 are input to the gates of the high frequency switches 126 and 127. The high frequency switches 126 and 127 sample the buffered signals S126P and S127P based on the sampling clock signals S39R and S40R, and output the sample hold signals S126Q and S127Q. Based on the amplitude level signal S125, the high frequency switches 126 and 127 also change the gain of the sample hold signals S126Q and S127Q to the buffered signals S126P and S127P. In a typical application the high frequency switches 126 and 127 lower the amplitude level signal S125 while linearly increasing the gain.

This eighth embodiment of the invention has the same effect as the first embodiment of the invention. That is, the serial buffer unit including resistances 11 and 12 absorbs impedance variations caused by the switching operation of the sampling unit. Variation in the amplified output signal S10 is thereby suppressed, and the level of the sample hold signals S126Q and S127Q is stabilized.

The serial buffer unit including the resistances 11 and 12 together with the parallel buffer unit 69 impedance match the amplified output signal S10. The power of the amplified output signal S10 is thereby maximized, and sample hold signals S126Q and S127Q with a high SNR are output.

The parallel buffer unit 69 also suppresses extraneous high frequencies above the specific frequency band to be received in the amplified output signal S10, and reduces distortion and noise from the sampling operation of the sampling unit. As a result, the level of the sample hold signals S126Q and S127Q is precisely controlled and the SNR is increased.

When a wireless receiver having the sampling receiver according to the present invention is in a weak field and the high frequency signal SP1 level is low, the amplified signals S129P and S129Q are input directly to the parallel buffer unit 69 without passing through the serial buffer unit including resistances 11 and 12. As a result, the low level amplified signals S129P and S129Q are not affected by the drop in SNR imposed by the serial buffer unit, and the SNR of the sample hold signals S126Q and S127Q rises. In addition, because the gain of the high frequency switches 126 and 127 rises as the amplitude level signal S125 drops, the sample hold signals S126Q and S127Q can be held constant regardless of the field conditions surrounding the wireless receiver.

### Embodiment 9

This ninth embodiment of the invention is described next primarily with reference to the differences between this embodiment and the foregoing embodiments. Other aspects of the configuration, operation, and effect of this embodiment are the same as the foregoing embodiment, and further description thereof is omitted.

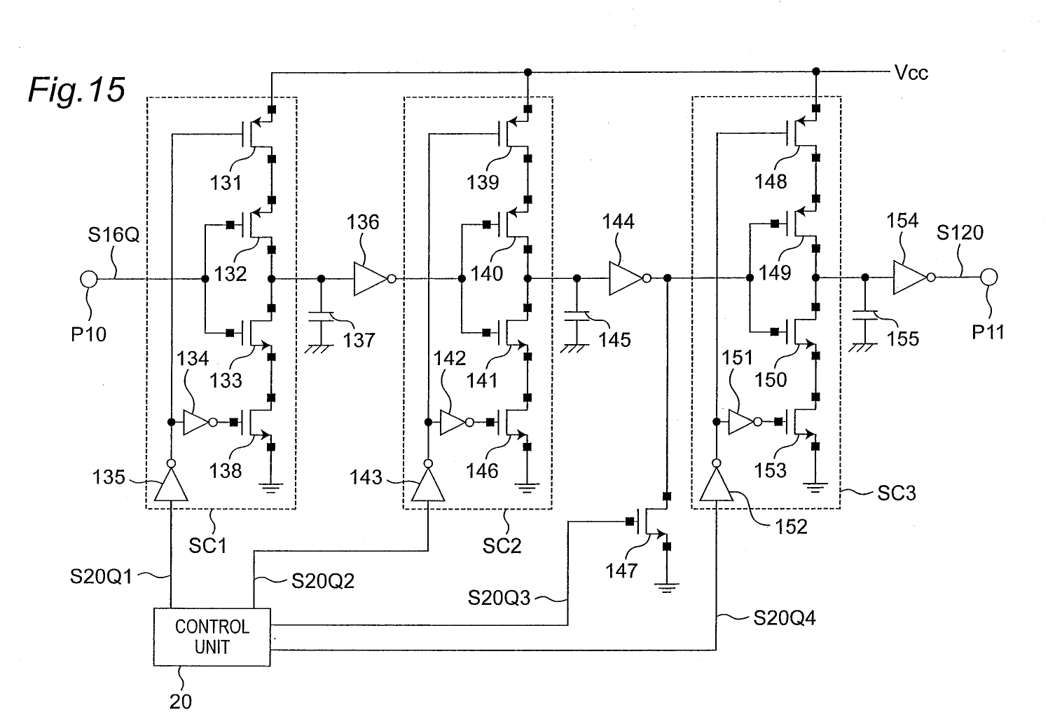

FIG. 15 is a circuit diagram of the switched capacitor filter 120, 121 in the first to eighth embodiments described above.

Because the phase of a signal input from P10 is inverted by the capacitance 137, an inverter 136 for phase correction is disposed downstream from the capacitance 137. Inserting this inverter 136 also prevents load fluctuations without being affected by the downstream switching operation. The desired characteristics can be achieved in the switched capacitor filter by cascading the circuits, and low distortion can be achieved because downstream switching operations are not propagated upstream.

The devices and operating principle shown in FIG. 15 are the same as shown in FIG. 2 and identified by the same reference numerals, and further description thereof is omitted.

The configuration shown in FIG. 15 is described from a different perspective below.

FIG. 15 is a typical example of the switched capacitor filters 120 and 121. The switched capacitor filter 120 includes a plurality of units each composed of two clocked inverters SC1 and SC2 cascaded with each other, a capacitance 137 parallel connected between clocked inverter SC1 and clocked inverter SC2, and an inverter 136 inserted in series between the capacitance 137 and clocked inverter SC2. Clocked inverter SC1 includes p-channel FETs 131 and 132, and n-channel FETs 133 and 138. Clocked inverter SC2 includes p-channel FETs 139 and 140, and n-channel FETs 141 and 146.

The switched capacitor clock signals S20Q1 and S20Q2 output by the control unit 20 cause the clocked inverters SC1 and SC2 to switch alternately on and off. For example, the sample hold signal S16Q shown in FIG. 1 charges the capacitance 137 when the clocked inverter SC1 is on and the clocked inverter SC2 is off, and when the clocked inverter SC1 is off and the clocked inverter SC2 is on, the signal stored in the capacitance 137 charges the downstream capacitance 145. The inverter 136 has a function for reversing the phase inversion of the signal by the capacitance 137. The inverter 136 also provides an isolation function that prevents load variation from the switching operation of the clocked inverter SC2 from affecting the signal charged to the capacitance 137 and the switching characteristic of the clocked inverter SC1.

### Experimental Results

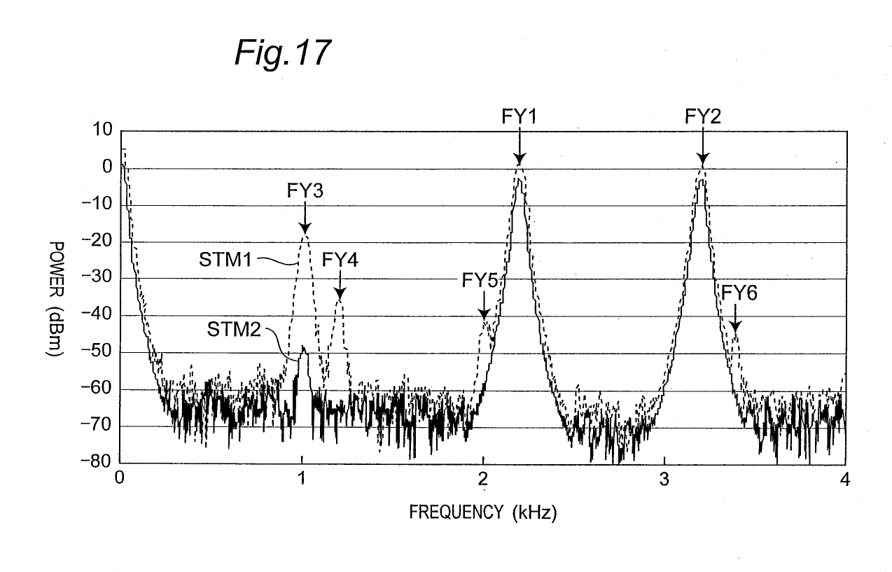

FIG. 17 is a frequency spectrogram of the limited sample hold signals S120 and S121 in the embodiments of the invention described above. Dotted curve STM1 is the frequency spectrogram when a buffer unit is not used, and solid curve STM2 is the frequency spectrogram when using a buffer unit.

The high frequency signal SP1 contains the two frequencies FX1 and FX2 shown below, and the sampling clock signals S16R and S17R have frequency FSC.
FX1=1.0022 MHz
FX2=1.0032 MHz
FSC=1 MHz

In this case, the sample hold signals S16Q and S17Q have the following frequencies FY1 and FY2.

FY1=FX1−FSC=2.2 kHz

FY2=FX2−FSC=3.2 kHz

The frequency spectrum of curve STM1 has a number of distortion components FY3, FY4, FY5, and FY6 caused by mutual modulation of the two signals of frequencies FY1 and FY2.

FY3=FY2−FY1=1.0 kHz

FY4=FY1×2−FY1=1.2 kHz

FY5=FY2×2−FY1×2=2.0 kHz

FY6=FY1×3−FY2=3.4 kHz

In the frequency spectrum STM2 achieved when a buffer unit is used, extraneous frequencies such as FY3 to FY6 are sufficiently reduced, and signal frequencies FY1 and FY2 to be received can be reproduced with a high SNR.

### SUMMARY

By disposing a buffer unit composed of a serial buffer unit and a parallel buffer unit between the amplifier unit and sampling unit, the sampling receiver according to the present invention has the following effect.

The serial buffer unit absorbs impedance fluctuations caused by the sampling operation of the sampling unit. As a result, variation in the amplified signal is suppressed and the sample hold signal level is stabilized.

The serial buffer unit and parallel buffer unit impedance match the amplified signal. As a result, amplified signal power is maximized, and a sample hold signal with a high SNR is generated.

The serial buffer unit and parallel buffer unit also suppress extraneous high frequencies above the specific frequency band to be received in the amplified signals, and reduce distortion and noise from the sampling operation of the sampling unit. As a result, the level of the sample hold signals is precisely controlled and the SNR is increased.

The buffer unit is composed of from a few to more than ten passive devices, and the area ratio of the buffer unit is small even when the entire sampling receiver according to this embodiment of the invention is integrated into a single semiconductor circuit or rendered as a module on the circuit board. In addition, the sampling receiver according to the invention provides the significant effect described above at a minimal increase in cost.

The invention can be advantageously used in a sampling receiver used in cell phones and other wireless circuits, and is particularly effective in sampling receivers that require a low distortion characteristic.

The invention can also be used in a sampling receiver.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A sampling receiver comprising:
an amplifier unit that amplifies a high frequency signal and generates an amplified signal;
a buffer unit that generates a buffer signal that impedance matches the amplified signal; and
a sampling unit that samples the buffer signal at a desired frequency, and generates a sample hold signal;
wherein said buffer unit absorbs impedance variation caused by the sampling operation of said sampling unit.

2. The sampling receiver described in claim 1, wherein:
said buffer unit comprises
a serial buffer unit inserted in series between said amplifier unit and said sampling unit, and
a parallel buffer unit inserted in parallel between said amplifier unit and said sampling unit.

3. The sampling receiver described in claim 2, wherein:
said serial buffer unit is inserted between said amplifier unit and said parallel buffer unit.

4. The sampling receiver described in claim 2, wherein:
said parallel buffer unit is inserted between said amplifier unit and said serial buffer unit.

5. The sampling receiver described in claim 2, wherein:
said serial buffer unit includes at least one of a resistor, an inductor, and a capacitor.

6. The sampling receiver described in claim 5, wherein:
said serial buffer unit includes a circuit having a parallel connected inductor and capacitor.

7. The sampling receiver described in claim 2, wherein:
said parallel buffer unit includes at least two of a resistor, an inductor, and a capacitor.

8. The sampling receiver described in claim 2, further comprising:
a control unit that supplies power to said sampling unit and controls switching the power supply on and off.

9. The sampling receiver described in claim 8, wherein:
said control unit is inserted between said serial buffer unit and said parallel buffer unit.

10. The sampling receiver described in claim 8, wherein:
said control unit is inserted between said buffer unit and said sampling unit.

11. The sampling receiver described in claim 2, wherein:
said buffer unit includes
a first secondary buffer unit that includes said serial buffer unit and said parallel buffer unit, and
a second secondary buffer unit that includes said parallel buffer unit;
the sampling receiver further comprises
a switch unit that selects a first channel through which the amplified signal is input to said first secondary buffer unit, or a second channel through which the amplified signal is input to said second secondary buffer unit, and
an amplitude level detection circuit that detects the amplitude level of the amplified signal and generates an amplitude level signal; and wherein:
said switch unit selects the channel based on the amplitude level signal; and
said buffer unit generates the buffer signal based on the amplified signal input thereto through the selected channel.

12. The sampling receiver described in claim 11, wherein:
said sampling unit changes the gain of the sample hold signal to the buffer signal based on the amplitude level signal.

13. The sampling receiver described in claim 1, wherein:
said amplifier unit generates an amplified signal on two channels based on a high frequency signal on one channel;
said buffer unit generates buffer signals on two channels based on the two amplified signals; and
said sampling unit generates sample hold signals on two channels based on the two buffer signals.

14. The sampling receiver described in claim 13, wherein said amplifier unit comprises:
a differential conversion circuit that generates opposite-phase amplifier input signals on two channels based on one high frequency signal; and
an amplifier circuit that amplifies the two amplified input signals and generates two opposite-phase amplified signals.

15. The sampling receiver described in claim 13, wherein said amplifier unit comprises:
an amplifier circuit that amplifies one high frequency signal and generates an amplified output signal on one channel; and
a branching circuit that splits the one amplified output signal and generates same-phase amplified signals on two channels.

16. The sampling receiver described in claim 13, wherein said amplifier unit comprises:
an amplifier circuit that amplifies one high frequency signal and generates an amplified output signal on one channel; and
a differential conversion circuit that generates opposite-phase amplified signals on two channels based on the one amplified output signal.

17. The sampling receiver described in claim 16, wherein:
said differential conversion circuit includes a differential inductor.

18. The sampling receiver described in claim 16, wherein:
said differential conversion circuit includes a differential transformer that converts a one-channel primary power signal to opposite-phase secondary power signals on two channels.

19. The sampling receiver described in claim 1, wherein:
said amplifier unit converts the high frequency signal voltage to current and generates the amplified signal.

20. The sampling receiver described in claim 1, further comprising:
a switched capacitor filter that limits the frequency band of the sample hold signal.

21. The sampling receiver described in claim 20, wherein:
said switched capacitor filter includes
at least first and second clocked inverters cascaded with each other;
a capacitor inserted in parallel between said first clocked inverter and said second clocked inverter; and
an inverter inserted in series between said capacitor and said second clocked inverter.
